(19) United States
(12) Patent Application Publication
(10) Pub. No.: US 2026/0362122 A1
(43) Pub. Date: Nov. 12, 2026

(54) SENSING SERVICE PRIVACY

(71) Applicant: Nokia Technologies Oy, Espoo (FI)

(72) Inventors: Apostolos KOUSARIDAS, Munich (DE); Shubranshu SINGH, Seeheim-Jugenheim (DE); Saurabh KHARE, Bangalore, Karnataka (IN)

(21) Appl. No.: 19/483,593

(22) PCT Filed: Mar. 26, 2024
(86) PCT No.: PCT/EP2024/058128

§ 371 Date: Nov. 11, 2025

(30) Foreign Application Priority Data
May 11, 2023 (IN) 202341033308

(51) Int. Cl. H04W 12/02; H04W 4/029

(52) U.S. Cl. CPC H04W 12/02; H04W 4/029

(57) ABSTRACT

There are provided measures for sensing service privacy. Such measures in one embodiment comprise generating sensing services related privacy profile information indicative of a profile type of a sensing services related privacy profile corresponding to said sensing services related privacy profile information, and transmitting said sensing services related privacy profile information, wherein said sensing services related privacy profile information include an indication whether sensing with respect to a profile type dependent sensing target associated with said sensing services related privacy profile information is allowed.

### FIELD

Various example embodiments relate to sensing service privacy. More specifically, various example embodiments relate to measures (including methods, apparatuses and computer program products) for realizing sensing service privacy.

### BACKGROUND

The present specification generally relates to sensing services and privacy aspects in relation to sensing services.

The goal of a sensing service is to obtain awareness of the scene surrounding a sensing device, which includes the capability to detect, localize and track objects, to form images, and/or to extract features for recognition/classification purposes, etc.

The integration of sensing and communication (ISAC) can help to achieve both high-data rate communications and high-resolution obstacle detection using the same hardware and spectrum resource. Different types of applications could benefit from the integrated sensing and communication services that a 5^{th} generation (5G) or beyond 5G system could provide.

The sensing service can be requested by a user equipment (UE) or an application function (AF), or an in-network client (e.g., location service (LCS) client) or a network function (NF).

### SUMMARY

Various example aspects of example embodiments are set out in the appended claims.

According to an example aspect, there is provided a method comprising generating sensing services related privacy profile information indicative of a profile type of a sensing services related privacy profile corresponding to said sensing services related privacy profile information, and transmitting said sensing services related privacy profile information, wherein said sensing services related privacy profile information include an indication whether sensing with respect to a profile type dependent sensing target associated with said sensing services related privacy profile information is allowed.

According to one example aspect, there is provided a method comprising receiving sensing services related privacy profile information indicative of a profile type of a sensing services related privacy profile corresponding to said sensing services related privacy profile information, and storing said sensing services related privacy profile information, wherein said sensing services related privacy profile information include an indication whether sensing with respect to a profile type dependent sensing target associated with said sensing services related privacy profile information is allowed.

According to one example aspect, there is provided a method comprising receiving a sensing service request, and performing a sensing privacy check in relation to said sensing service request based on sensing services related privacy profile information indicative of a profile type of a sensing services related privacy profile corresponding to said sensing services related privacy profile information, wherein said sensing services related privacy profile information include an indication whether sensing with respect to a profile type dependent sensing target associated with said sensing services related privacy profile information is allowed.

According to one example aspect, there is provided an apparatus comprising generating circuitry configured to generate sensing services related privacy profile information indicative of a profile type of a sensing services related privacy profile corresponding to said sensing services related privacy profile information, and transmitting circuitry configured to transmit said sensing services related privacy profile information, wherein said sensing services related privacy profile information include an indication whether sensing with respect to a profile type dependent sensing target associated with said sensing services related privacy profile information is allowed.

According to one example aspect, there is provided an apparatus comprising receiving circuitry configured to receive sensing services related privacy profile information indicative of a profile type of a sensing services related privacy profile corresponding to said sensing services related privacy profile information, and storing circuitry configured to store said sensing services related privacy profile information, wherein said sensing services related privacy profile information include an indication whether sensing with respect to a profile type dependent sensing target associated with said sensing services related privacy profile information is allowed.

According to one example aspect, there is provided an apparatus comprising receiving circuitry configured to receive a sensing service request, and performing circuitry configured to perform a sensing privacy check in relation to said sensing service request based on sensing services related privacy profile information indicative of a profile type of a sensing services related privacy profile corresponding to said sensing services related privacy profile information, wherein said sensing services related privacy profile information include an indication whether sensing with respect to a profile type dependent sensing target associated with said sensing services related privacy profile information is allowed.

According to one example aspect, there is provided an apparatus comprising at least one processor, at least one memory including computer program code, and at least one interface configured for communication with at least another apparatus, the at least one processor, with the at least one memory and the computer program code, being configured to cause the apparatus to perform generating sensing services related privacy profile information indicative of a profile type of a sensing services related privacy profile corresponding to said sensing services related privacy profile information, and transmitting said sensing services related privacy profile information, wherein said sensing services related privacy profile information include an indication whether sensing with respect to a profile type dependent sensing target associated with said sensing services related privacy profile information is allowed.

According to one example aspect, there is provided an apparatus comprising at least one processor, at least one memory including computer program code, and at least one interface configured for communication with at least another apparatus, the at least one processor, with the at least one memory and the computer program code, being configured to cause the apparatus to perform receiving sensing services related privacy profile information indicative of a profile type of a sensing services related privacy profile corresponding to said sensing services related privacy profile information, and storing said sensing services related privacy profile information, wherein said sensing services related privacy profile information include an indication whether sensing with respect to a profile type dependent sensing target associated with said sensing services related privacy profile information is allowed.

According to one example aspect, there is provided an apparatus comprising at least one processor, at least one memory including computer program code, and at least one interface configured for communication with at least another apparatus, the at least one processor, with the at least one memory and the computer program code, being configured to cause the apparatus to perform receiving a sensing service request, and performing a sensing privacy check in relation to said sensing service request based on sensing services related privacy profile information indicative of a profile type of a sensing services related privacy profile corresponding to said sensing services related privacy profile information, wherein said sensing services related privacy profile information include an indication whether sensing with respect to a profile type dependent sensing target associated with said sensing services related privacy profile information is allowed. According to one example aspect, there is provided a computer program product comprising computer-executable computer program code which, when the program is run on a computer (e.g. a computer of an apparatus according to any one of the aforementioned apparatus-related example aspects of the present disclosure), is configured to cause the computer to carry out the method according to any one of the aforementioned method-related example aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient provision of privacy profiles appropriate for sensing service as well as of privacy checks for sensing services. Various of the above aspects may solve at least part of the problems and drawbacks identified herein in relation to the prior art.

By way of example embodiments, there is provided sensing service privacy. More specifically, by way of example embodiments, there are provided measures and mechanisms for realizing sensing service privacy.

Thus, improvement is achieved by methods, apparatuses and computer program products enabling/realizing sensing service privacy.

### BRIEF DESCRIPTION OF THE DRAWINGS

In the following, the present disclosure will be described in greater detail by way of non-limiting examples with reference to the accompanying drawings, in which

FIG. 1 is a block diagram illustrating an apparatus according to example embodiments,

FIG. 2 is a block diagram illustrating an apparatus according to example embodiments,

FIG. 3 is a block diagram illustrating an apparatus according to example embodiments,

FIG. 4 is a block diagram illustrating an apparatus according to example embodiments,

FIG. 5 is a block diagram illustrating an apparatus according to example embodiments,

FIG. 6 is a block diagram illustrating an apparatus according to example embodiments,

FIG. 7 is a schematic diagram of a procedure according to example embodiments,

FIG. 8 is a schematic diagram of a procedure according to example embodiments,

FIG. 9 is a schematic diagram of a procedure according to example embodiments,

FIG. 10 shows a schematic diagram of signaling sequences according to example embodiments,

FIG. 11 shows a schematic diagram of signaling sequences according to example embodiments,

FIG. 12 shows a schematic diagram of signaling sequences according to example embodiments,

FIG. 13 shows a schematic diagram of signaling sequences according to example embodiments,

FIG. 14 shows a schematic diagram of signaling sequences according to example embodiments, and

FIG. 15 is a block diagram alternatively illustrating apparatuses according to example embodiments.

### DETAILED DESCRIPTION

The present disclosure is described herein with reference to particular non-limiting examples and to what are presently considered to be conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain example network configurations and deployments. Namely, the present disclosure and its embodiments are mainly described in relation to 3GPP specifications being used as non-limiting examples for certain example network configurations and deployments. As such, the description of example embodiments given herein specifically refers to terminology which is directly related thereto. Such terminology is only used in the context of the presented non-limiting examples, and does naturally not limit the disclosure in any way. Rather, any other communication or communication related system deployment, etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

As used herein, “at least one of the following:” and “at least one of” and similar wording, where the list of two or more elements are joined by “and” or “or”, mean at least any one of the elements, or at least any two or more of the elements, or at least all the elements.

Ensuring data privacy of the sensing service and the sensed objects is a key functionality that should be provided by a 5G and beyond communication system. Since Sensing may be almost for the whole environment under a radio frequency (RF) signal coverage, the privacy of sensing operation is an important consideration factor for real deployment.

For the private area, the private permission is required for sensing operation from such as a homeowner for in-home sensing or the building management for in-building sensing. For public areas, such as public road, park and airport, it is required to obtain a permission of the public area management. For specific objects (e.g., rain), content of the sensing result report is limited according to the authority of the sensing requester, for example, climate and rainfall detection can be reported to the Meteorological Bureau.

For the sensed object that supports 3^{rd} Generation Partnership Project (3GPP) UE capability, the 5GS should notify the UE about the sensing event and ensure consent of the user before sensing the object.

These privacy policies need to be configured on the 5GS and can be flexibly modified by the related parties under the operator control.

There are various applications that could benefit by sensing services, which could be realized at various environments (e.g., public environments such as roads, indoor areas such as industrial premises), and sensing different type of information (e.g., vehicle, people, buildings, health features, environmental features, etc.), that may be privacy sensitive.

The different use cases have different privacy requirements, which is important to be embedded in the ISAC systems of 5G and beyond systems, and allow the data owner to define privacy rules and to use them in the different sensing methods and requests.

The existing privacy mechanisms defined for LCS have been developed having as a core part of their rational a specific UE, described e.g., by its subscription permanent identifier (SUPI). However, this is not adequate for the sensing services.

Namely, either there is no existing privacy profile data maintained in the 5G Core network or the existing privacy profile data does not support many of the privacy requirements that several use cases have, as follows:
to allow or not the sensing of a defined region or geographical area (non UE privacy aspect),
to allow or not the detection of connected objects that do not have a SUPI or in general cannot be described with communication related identifiers, and
to obfuscate or hide or change important/sensitive features (e.g., size, shape, etc.) of detected objects.

Further, sensing requests from UE or AF to 5GC should also pass through the required privacy checks, since the area around a UE may include sensitive privacy data (e.g., objects, features, etc.), which is something that is not supported and not needed in the LCS related privacy checks.

In particular, it is known that a UE can generate (or update) the UE Location Privacy Indication, and that the UE sends the Location Privacy Indication to the AMF in N1 NAS message. The UE Location Privacy Indication indicates whether it allows or disallows responding to the subsequent LCS requests for the UE. Then, an access and mobility function (AMF) invokes a Nudm_ParameterProvision_Update (LCS privacy) service operation towards a unified data management (UDM), and the service operation carries the Location Privacy Indication information. The UDM stores or updates the UE LCS privacy profile in a unified data repository (UDR) by invoking a Nudr_DM_Update (SUPI, Subscription Data) service operation accordingly.

Further, it is known that, in the case of a location service request, the target UE's privacy profile settings shall always be checked in the UE's home public land mobile network (PLMN) prior to delivering a location estimate. Specifically, the (H)GMLC invokes a Nudm_SDM_Get service operation towards the UDM of the target UE to get the privacy settings of the UE identified by its GPSI or SUPI.

The UDM returns the target UE Privacy setting of the UE and the (H)GMLC checks the UE LCS privacy profile. If the target UE is not allowed to be located, then location information of the respective UE is not provided. Similar privacy check takes place before providing location information.

It is further envisaged that a 5G system shall be able to provide a secure mechanism to ensure sensing result data privacy within the sensing service area. In other words, the need for privacy considerations in the sensing services is recognized, but not addressed in existing specifications yet, considering the specific requirements that sensing procedures have.

In other words, overall, existing/envisaged 5G system does not have specified privacy functionality for the sensing services, which have new requirements, as described above.

Hence, the problem arises that privacy functionality for the sensing services is needed.

Hence, there is a need to provide for sensing service privacy.

Various example embodiments aim at addressing at least part of the above issues and/or problems and drawbacks.

According to example embodiments, in general terms, there are provided measures and mechanisms for (enabling/realizing) sensing service privacy.

In particular, according to example embodiments, approaches are provided on how e.g., an AF and a UE can define privacy profiles appropriate for a sensing service as well as on new privacy checks needed for sensing services.

Namely, in brief, according to example embodiments, profiles, methods and functionalities (e.g. 5GS specific functionalities) to enable privacy checks for sensing services in the 5G system are provided.

Heretofore, first, new privacy profiles and their management are defined.

Such new sensing privacy profiles are defined to support various types of sensing services including user and non-user related privacy data.

According to example embodiments, the following types of sensing privacy profiles are introduced:
location-aware sensing privacy indication,
UE sensing privacy indication, and
object-aware sensing privacy indication.
For example, said profile type may be at least one of the following: location aware type, a terminal type or an object aware type.

The new sensing privacy profiles according to example embodiments provide information for the configuration and execution of a sensing procedure as well as about whether and which sensing data outputs should be exposed.

Heretofore, according to example embodiments, a UDM is enhanced to store and manage user/subscriber related privacy profile information (e.g., UE sensing privacy indication), while non-user related privacy information (e.g., location-aware sensing privacy indication and object-aware sensing privacy indication) can be stored and managed by a new function according to example embodiments, e.g., a sensing management function (SeMF) and/or a repository according to example embodiments, e.g., a sensing data management (SDM), or this sensing data management can be implemented in an existing network function.

Further, according to example embodiments, signaling is defined to configure and update at the UDM and/or the SeMF or any other network function (NF) the sensing privacy profiles generated or updated by an external entity via an AF or by a UE.

Further and second, enforcement of the privacy and rules is defined.

Heretofore, according to example embodiments, a method is provided to enable the sensing privacy checks at the SeMF before the initiation of a sensing procedure, based on the sensing service request by a sensing client and taking into consideration the appropriate sensing privacy profiles.

In particular, according to example embodiments, the SeMF determines the appropriate sensing configuration according to restrictions or parameters provided by retrieved sensing privacy profiles. Further, according to example embodiments, sensing privacy checks can be performed by the SeMF after finalization of the sensing procedure to determine/check the sensing outputs that could be exposed from the SeMF to the sensing client, according to the relevant sensing privacy profiles.

In addition, signaling and procedures for privacy check in a sensing service request are defined, while enhancements on the LCS-based architecture, the GMLC function and interfaces/methods of existing location service are provided to enable sensing privacy checks for sensing service requests that use the LCS architecture. According to example embodiments, further, sensing privacy profiles may initiate obfuscation of the sensed data (e.g., obfuscate objects or specific type of objects) and may provide information on the obfuscation configuration, method, etc., that takes place at the SeMF or RAN or another NF.

Example embodiments are specified below in more detail.

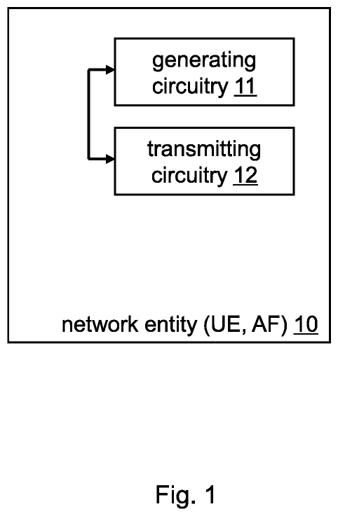

FIG. 1 is a block diagram illustrating an apparatus according to example embodiments. The apparatus may be a network node or entity 10, such as a user equipment or an application function entity, comprising a generating circuitry 11 and a transmitting circuitry 12. The generating circuitry 11 generates sensing services related privacy profile information indicative of a profile type of a sensing services related privacy profile corresponding to said sensing services related privacy profile information. In one example embodiment, a sensing services related privacy profile comprises a privacy profile related to a sensing service; the privacy profile may be of a policy type which may be, for example, a location-aware type, a UE type, and an object-aware type; sensing services related privacy profile information includes the sensing services related privacy profile and a profile type for the sensing services related privacy profile.

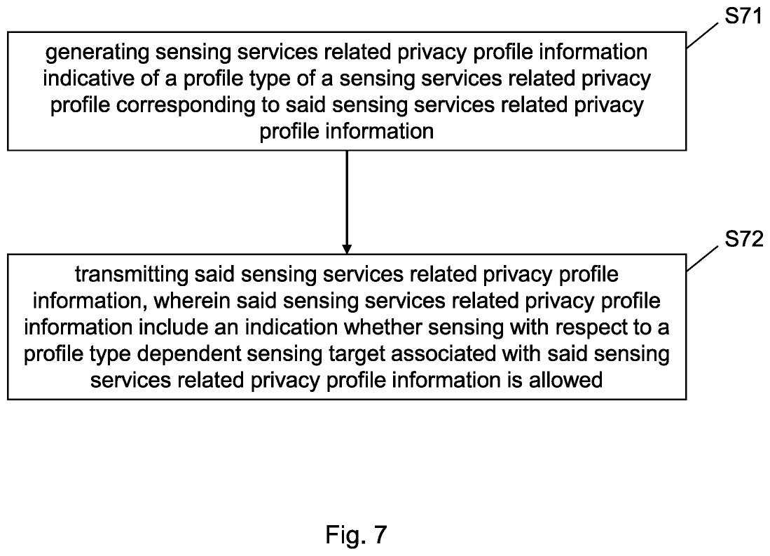

The transmitting circuitry 12 transmits said sensing services related privacy profile information. The sensing services related privacy profile information include an indication whether sensing with respect to a profile type dependent sensing target associated with said sensing services related privacy profile information is allowed. In one example embodiment, said sensing services related privacy profile information includes a profile type dependent sensing target and an indication whether sensing with respect to the profile type dependent sensing target is allowed; a profile type dependent sensing target comprises a target whose sensing is dependent upon the profile type of the target. FIG. 7 is a schematic diagram of a procedure according to example embodiments. The apparatus according to FIG. 1 may perform the method of FIG. 7 but is not limited to this method. The method of FIG. 7 may be performed by the apparatus of FIG. 1 but is not limited to being performed by this apparatus.

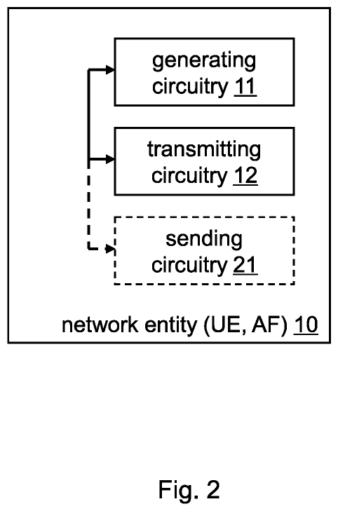

As shown in FIG. 7, a procedure according to example embodiments comprises an operation of generating (S71) sensing services related privacy profile information indicative of a profile type of a sensing services related privacy profile corresponding to said sensing services related privacy profile information, and an operation of transmitting (S72) said sensing services related privacy profile information. The sensing services related privacy profile information include an indication whether sensing with respect to a profile type dependent sensing target associated with said sensing services related privacy profile information is allowed. FIG. 2 is a block diagram illustrating an apparatus according to example embodiments. In particular, FIG. 2 illustrates a variation of the apparatus shown in FIG. 1. The apparatus according to FIG. 2 may thus further comprise a sending circuitry 21.

In an embodiment at least some of the functionalities of the apparatus shown in FIG. 1 (or 2) may be shared between two physically separate devices forming one operational entity. Therefore, the apparatus may be seen to depict the operational entity comprising one or more physically separate devices for executing at least some of the described processes.

According to further example embodiments, said profile type is at least one of the following:
location-aware sensing privacy related,
terminal sensing privacy related, or
object-aware sensing privacy related.

For example, said profile type may be at least one of the following: location aware type, a terminal type or an object aware type.

According to example embodiments, examples for a terminal include user equipments (UE), vehicles with communication capabilities, drones with communication capabilities, robots with communication capabilities, etc.

According to further example embodiments, said profile type is location-aware sensing privacy related, and said sensing services related privacy profile information include at least one of the following:
information on a geographical area corresponding to said profile type dependent sensing target,
information on a sensing allowance configuration,
information on a validity time of said sensing services related privacy profile information,
information on exceptions from said sensing services related privacy profile information,
information on objects obfuscation,
information on a validity time of said indication,
information on receivers of outputs of a sensing procedure considering said sensing services related privacy profile information, or
information on a setting entity setting said sensing services related privacy profile information.

According to example embodiments, examples for obfuscation or obfuscation processing (or masking, blurring) include, obfuscating or hiding or changing important/sensitive features (e.g., location, size, shape, etc.) of detected objects. According to further example embodiments, said profile type is terminal sensing privacy related, and said sensing services related privacy profile information include at least one of the following:
information on a sensing allowance configuration,
information on a geographical area for which said indication is valid,
information on a time or time period for which said indication is valid, or
information on a sensing services role of said profile type dependent sensing target.

According to further example embodiments, said profile type is object-aware sensing privacy related, and said sensing services related privacy profile information include at least one of the following:
information on an object type of said profile type dependent sensing target,
information on a sensing allowance configuration, or
information on receivers of outputs of a sensing procedure considering said sensing services related privacy profile information.

According to further example embodiments, said sensing allowance configuration defines at least one of the following:
that obfuscation of object features is enabled, or
that no identifier of an object or a terminal is indicated.

According to a variation of the procedure shown in FIG. 7, example details of the transmitting operation (S72) are given, which are inherently independent from each other as such. Such example transmitting operation (S72) according to example embodiments may comprise an operation of sending said sensing services related privacy profile information with a sensing services privacy profile setting request or a sensing services privacy profile create request or a sensing services privacy profile update request.

According to a variation of the procedure shown in FIG. 7, example additional operations are given, which are inherently independent from each other as such. According to such variation, an example method according to example embodiments may comprise an operation of transmitting a sensing services privacy profile deletion request indicative of a sensing services related privacy profile.

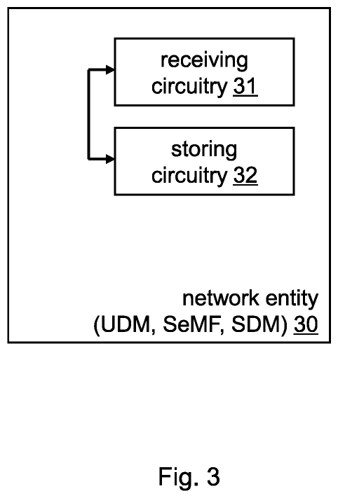

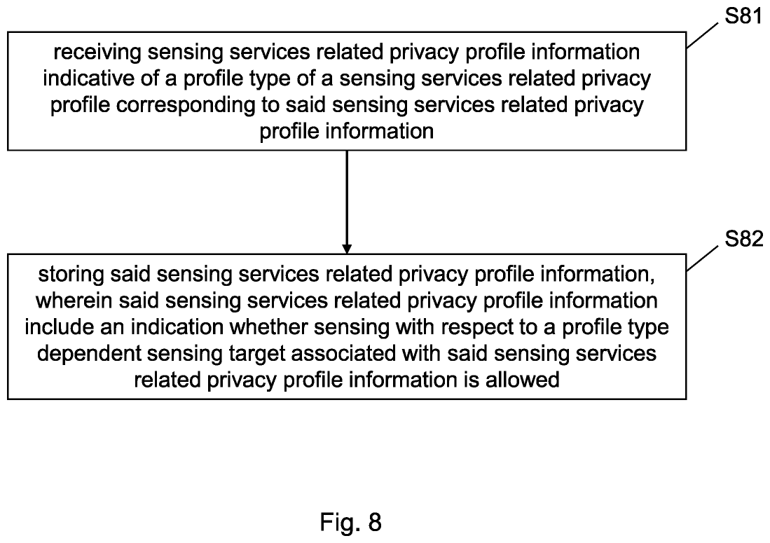

FIG. 3 is a block diagram illustrating an apparatus according to example embodiments. The apparatus may be a network node or entity 30, such as a unified data management entity or a sensing management function entity or a sensing data management entity or an entity providing such functionality, comprising a receiving circuitry 31 and a storing circuitry 32. The receiving circuitry 31 receives sensing services related privacy profile information indicative of a profile type of a sensing services related privacy profile corresponding to said sensing services related privacy profile information. The storing circuitry 32 stores said sensing services related privacy profile information. The sensing services related privacy profile information include an indication whether sensing with respect to a profile type dependent sensing target associated with said sensing services related privacy profile information is allowed. FIG. 8 is a schematic diagram of a procedure according to example embodiments. The apparatus according to FIG. 3 may perform the method of FIG. 8 but is not limited to this method. The method of FIG. 8 may be performed by the apparatus of FIG. 3 but is not limited to being performed by this apparatus.

As shown in FIG. 8, a procedure according to example embodiments comprises an operation of receiving (S81) sensing services related privacy profile information indicative of a profile type of a sensing services related privacy profile corresponding to said sensing services related privacy profile information, and an operation of storing (S82) said sensing services related privacy profile information. The sensing services related privacy profile information include an indication whether sensing with respect to a profile type dependent sensing target associated with said sensing services related privacy profile information is allowed.

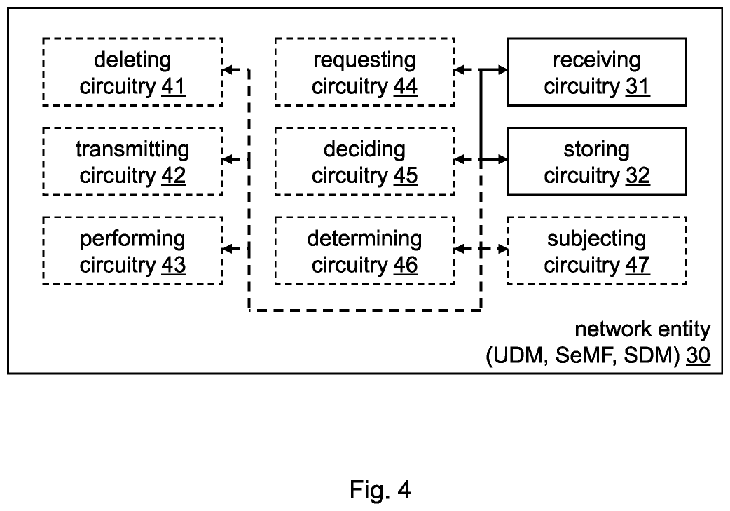

FIG. 4 is a block diagram illustrating an apparatus according to example embodiments. In particular, FIG. 4 illustrates a variation of the apparatus shown in FIG. 3. The apparatus according to FIG. 4 may thus further comprise a deleting circuitry 41, a transmitting circuitry 42, a performing circuitry 43, a requesting circuitry 44, a deciding circuitry 45, a determining circuitry 46, and/or a subjecting circuitry 47.

In an embodiment at least some of the functionalities of the apparatus shown in FIG. 3 (or 4) may be shared between two physically separate devices forming one operational entity. Therefore, the apparatus may be seen to depict the operational entity comprising one or more physically separate devices for executing at least some of the described processes.

According to a variation of the procedure shown in FIG. 8, example additional operations are given, which are inherently independent from each other as such. According to such variation, an example method according to example embodiments may comprise an operation of determining at least one network entity to store the received sensing services related privacy profile information.

According to further example embodiments, said storage device comprises at least one of a unified data repository (UDR) or unified data management (UDM) or a Sensing Management Function (SeMF) or any storage database.

Namely, UE specific sensing privacy setting may be initiated by a UE and sensing privacy setting may be initiated by a transmitter (e.g. AF).

Accordingly, according to example embodiments, the transmitter (e.g. AF) may send via NEF and not directly to UDM, SeMF, SDM, and then, the NEF may decide whether to store in the UDM/UDR or the SeMF. On the other hand, according to example embodiments, the UE may send directly to the UDM (SeMF, SDM), and then it may be always stored in the UDM.

According to further example embodiments, said profile type is at least one of the following:
location-aware sensing privacy related,
terminal sensing privacy related, or
object-aware sensing privacy related.

According to further example embodiments, said profile type is location-aware sensing privacy related, and said sensing services related privacy profile information include at least one of the following:
information on a geographical area corresponding to said profile type dependent sensing target,
information on a sensing allowance configuration,
information on a validity time of said sensing services related privacy profile information,
information on exceptions from said sensing services related privacy profile information,
information on objects obfuscation,
information on a validity time of said indication,
information on receivers of outputs of a sensing procedure considering said sensing services related privacy profile information, or
information on a setting entity setting said sensing services related privacy profile information.

According to further example embodiments, said profile type is terminal sensing privacy related, and said sensing services related privacy profile information include at least one of the following:
information on a sensing allowance configuration,
information on a geographical area for which said indication is valid,
information on a time or time period for which said indication is valid, or
information on a sensing services role of said profile type dependent sensing target.

According to further example embodiments, said profile type is object-aware sensing privacy related, and said sensing services related privacy profile information include at least one of the following:
information on an object type of said profile type dependent sensing target,
information on a sensing allowance configuration, or
information on receivers of outputs of a sensing procedure considering said sensing services related privacy profile information.

According to further example embodiments, said sensing allowance configuration defines at least one of the following:
that obfuscation of object features is enabled, or
that no identifier of an object or a terminal is indicated.

According to further example embodiments, said sensing services related privacy profile information are received with a sensing services privacy profile setting request or a sensing services privacy profile create request or a sensing services privacy profile update request.

According to a variation of the procedure shown in FIG. 8, example additional operations are given, which are inherently independent from each other as such. According to such variation, an example method according to example embodiments may comprise an operation of receiving a sensing services privacy profile deletion request indicative of a sensing services related privacy profile, and an operation of deleting said sensing services related privacy profile information corresponding to said sensing services related privacy profile.

According to a variation of the procedure shown in FIG. 8, example additional operations are given, which are inherently independent from each other as such. According to such variation, an example method according to example embodiments may comprise an operation of transmitting, to at least one subscriber entity, a subscription notification indicative of a sensing services related privacy profile change.

According to a variation of the procedure shown in FIG. 8, example additional operations are given, which are inherently independent from each other as such. According to such variation, an example method according to example embodiments may comprise an operation of receiving a sensing service request, and an operation of performing a sensing privacy check in relation to said sensing service request based on said sensing services related privacy profile information.

According to a variation of the procedure shown in FIG. 8, example additional operations are given, which are inherently independent from each other as such. According to such variation, an example method according to example embodiments may comprise an operation of requesting said sensing services related privacy profile information.

According to a variation of the procedure shown in FIG. 8, example additional operations are given, which are inherently independent from each other as such. According to such variation, an example method according to example embodiments may comprise an operation of deciding, based on a result of said sensing privacy check, on initiating a sensing procedure corresponding to said sensing service request.

According to a variation of the procedure shown in FIG. 8, example additional operations are given, which are inherently independent from each other as such. According to such variation, an example method according to example embodiments may comprise an operation of determining a sensing configuration for said sensing procedure based on said sensing services related privacy profile information.

According to a variation of the procedure shown in FIG. 8, example additional operations are given, which are inherently independent from each other as such. According to such variation, an example method according to example embodiments may comprise an operation of receiving sensing results in relation to said sensing procedure, and an operation of determining a sensing output based on said sensing results.

According to example embodiments, examples for sensing results (or sensing measurement information or sensing data) include data derived from radio signals (e.g., 3GPP, non-3GPP, WiFi, radar, Lidars, etc.) impacted (e.g. reflected, refracted, diffracted) by an object or environment of interest for sensing purposes, and optionally processed (e.g., within a 5G/6G system, external server, application server, edge server, etc.).

According to example embodiments, examples for sensing output include processed sensing data e.g. requested by a service consumer.

According to a variation of the procedure shown in FIG. 8, example details of the determining operation are given, which are inherently independent from each other as such. Such example determining operation according to example embodiments may comprise an operation of subjecting said sensing results to an obfuscation processing based on said sensing services related privacy profile information, and/or an operation of subjecting said sensing results to a sensing privacy check based on said sensing services related privacy profile information.

According to a variation of the procedure shown in FIG. 8, example additional operations are given, which are inherently independent from each other as such. According to such variation, an example method according to example embodiments may comprise an operation of deciding, based on a result of said obfuscation processing and/or a result of said sensing privacy check, to transmit said sensing results to a sensing consumer, or an operation of deciding, based on said result of said obfuscation processing and/or said result of said sensing privacy check, to modify features of said sensing results and to transmit said modified sensing results to a sensing consumer.

According to further example embodiments, said sensing configuration includes an obfuscation configuration. Alternatively, or in addition, according to further example embodiments, said sensing results include obfuscated sensing results.

According to further example embodiments, said obfuscation configuration includes at least one of the following:
information on object features to be obfuscated,
information on an obfuscation type, or
information on object feature removal.

According to a variation of the procedure shown in FIG. 8, example additional operations are given, which are inherently independent from each other as such. According to such variation, an example method according to example embodiments may comprise an operation of transmitting said obfuscation configuration.

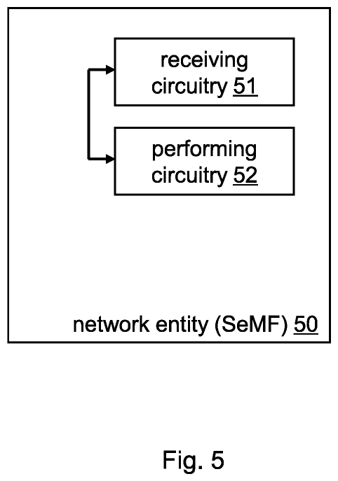

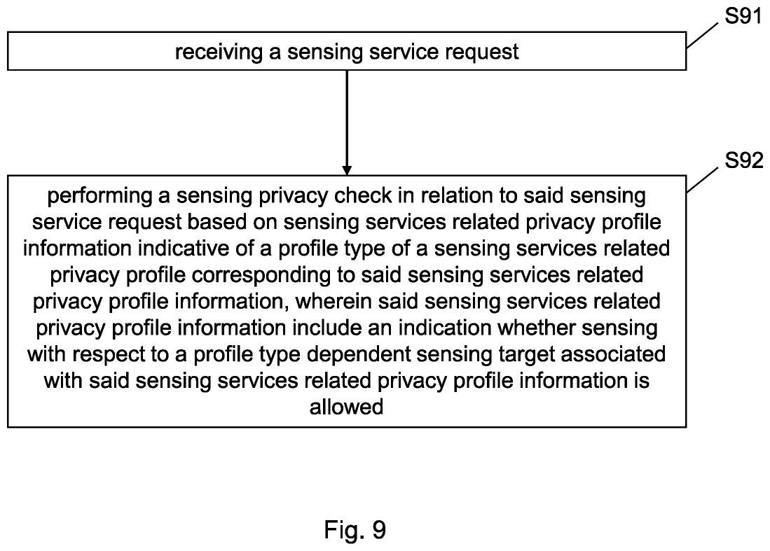

FIG. 5 is a block diagram illustrating an apparatus according to example embodiments. The apparatus may be a network node or entity 50, such as a sensing management function entity or a sensing data management entity or an entity providing such functionality, comprising a receiving circuitry 51 and a performing circuitry (or checking circuitry) 52. The receiving circuitry 51 receives a sensing service request. The performing circuitry (or checking circuitry) 52 performs a sensing privacy check in relation to said sensing service request based on sensing services related privacy profile information indicative of a profile type of a sensing services related privacy profile corresponding to said sensing services related privacy profile information. The sensing services related privacy profile information include an indication whether sensing with respect to a profile type dependent sensing target associated with said sensing services related privacy profile information is allowed. FIG. 9 is a schematic diagram of a procedure according to example embodiments. The apparatus according to FIG. 5 may perform the method of FIG. 9 but is not limited to this method. The method of FIG. 9 may be performed by the apparatus of FIG. 5 but is not limited to being performed by this apparatus.

As shown in FIG. 9, a procedure according to example embodiments comprises an operation of receiving (S91) a sensing service request, and an operation of performing (S92) a sensing privacy check in relation to said sensing service request based on sensing services related privacy profile information indicative of a profile type of a sensing services related privacy profile corresponding to said sensing services related privacy profile information. The sensing services related privacy profile information include an indication whether sensing with respect to a profile type dependent sensing target associated with said sensing services related privacy profile information is allowed.

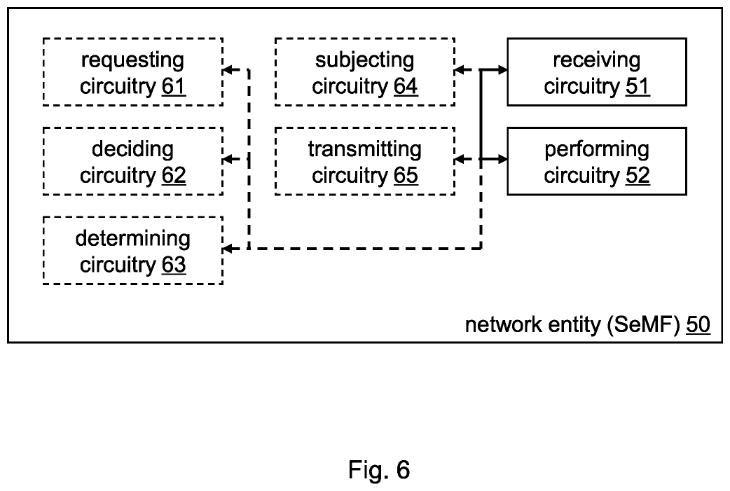

FIG. 6 is a block diagram illustrating an apparatus according to example embodiments. In particular, FIG. 6 illustrates a variation of the apparatus shown in FIG. 5. The apparatus according to FIG. 6 may thus further comprise a requesting circuitry 61, a deciding circuitry 62, a determining circuitry 63, a subjecting circuitry 64, and/or a transmitting circuitry 65.

In an embodiment at least some of the functionalities of the apparatus shown in FIG. 5 (or 6) may be shared between two physically separate devices forming one operational entity. Therefore, the apparatus may be seen to depict the operational entity comprising one or more physically separate devices for executing at least some of the described processes.

According to a variation of the procedure shown in FIG. 9, example additional operations are given, which are inherently independent from each other as such. According to such variation, an example method according to example embodiments may comprise an operation of requesting said sensing services related privacy profile information.

According to a variation of the procedure shown in FIG. 9, example additional operations are given, which are inherently independent from each other as such. According to such variation, an example method according to example embodiments may comprise an operation of deciding, based on a result of said sensing privacy check, on initiating a sensing procedure corresponding to said sensing service request.

According to a variation of the procedure shown in FIG. 9, example additional operations are given, which are inherently independent from each other as such. According to such variation, an example method according to example embodiments may comprise an operation of determining a sensing configuration for said sensing procedure based on said sensing services related privacy profile information.

According to a variation of the procedure shown in FIG. 9, example additional operations are given, which are inherently independent from each other as such. According to such variation, an example method according to example embodiments may comprise an operation of receiving sensing results in relation to said sensing procedure, and an operation of determining a sensing output based on said sensing results.

According to example embodiments, examples for sensing results (or sensing measurement information or sensing data) include data derived from radio signals (e.g., 3GPP, non-3GPP, WiFi, radar, Lidars, etc.) impacted (e.g. reflected, refracted, diffracted) by an object or environment of interest for sensing purposes, and optionally processed (e.g., within a 5G/6G system, external server, application server, edge server, etc.).

According to example embodiments, examples for sensing output include processed sensing data e.g. requested by a service consumer.

According to a variation of the procedure shown in FIG. 8, example details of the determining operation are given, which are inherently independent from each other as such. Such example determining operation according to example embodiments may comprise an operation of subjecting said sensing results to an obfuscation processing based on said sensing services related privacy profile information, and/or an operation of subjecting said sensing results to a sensing privacy check based on said sensing services related privacy profile information.

According to a variation of the procedure shown in FIG. 9, example additional operations are given, which are inherently independent from each other as such. According to such variation, an example method according to example embodiments may comprise an operation of deciding, based on a result of said obfuscation processing and/or a result of said sensing privacy check, to transmit said sensing results to a sensing consumer, or an operation of deciding, based on said result of said obfuscation processing and/or said result of said sensing privacy check, to modify features of said sensing results and to transmit said modified sensing results to a sensing consumer.

According to further example embodiments, said sensing configuration includes an obfuscation configuration. Alternatively, or in addition, according to further example embodiments, said received sensing results include obfuscated sensing results.

According to further example embodiments, said obfuscation configuration includes at least one of the following:
information on object features to be obfuscated,
information on an obfuscation type, or
information on object feature removal.

According to a variation of the procedure shown in FIG. 9, example additional operations are given, which are inherently independent from each other as such. According to such variation, an example method according to example embodiments may comprise an operation of transmitting said obfuscation configuration.

Example embodiments outlined and specified above are explained below in more specific terms.

With respect to the above outlined definition of new privacy profiles and their management to address the issue how an AF and a UE can define privacy profiles appropriate for a sensing service, according to example embodiments, sensing privacy profiles may be implemented as follows.

In detail, according to example embodiments, new privacy profiles are defined, and may be set and stored in the core network (CN) (e.g., in the UDM for UE specific profile and a new NF for non UE specific privacy profile) to allow or disallow the sensing service. Three types of privacy profiles have been identified:
a) Location-aware sensing privacy indication may include one or more of the following information elements:
   Geographical area description, e.g., using GPS coordinates, everywhere, etc.,
   Sensing is allowed (default),
   Sensing is disallowed,
   Time period that the sensing privacy indication is valid,
   Type of objects sensing privacy indication are excepted,
   Enable objects obfuscation,
   (Optionally) define the selected configuration or method for obfuscation/masking/blurring of defined or all identified objects,
   Timestamp or time period that sensing is allowed or not,
   Sensing outputs are provided to defined receivers, in terms of type of consumer, or defined IPs,
   sensing privacy indication setter, e.g., AF, UE, etc.
b) UE sensing privacy indication may include one or more of the following information elements:
   Sensing is allowed (default),
   Sensing is disallowed,
   Sensing is allowed with specific configuration,
   Enable obfuscation of features of the object,
   No indication of identifier e.g., SUPI, Geographical area where sensing is allowed or disallowed,
   Timestamp,
   Participation (e.g., as sounder or initiator or sensing signals transmitter) for sensing is allowed or not,
   This is applicable for the case that a UE is requested by another UE or by the network to initiate a sensing procedure.
c) Object-aware sensing privacy indication may include one or more of the following information elements:
   Object type,
   Descriptor of an object category (e.g., people, vehicle) or an object's feature (e.g., size, mobility profile, etc.),
   Identifier,
   Sensing is allowed (default),
   Sensing is disallowed,
   Sensing is allowed with specific configuration,
   Enable obfuscation of features of the object,
   No indication of identifier e.g., SUPI,
   Sensing outputs are provided to defined receivers, in terms of type of consumer, or defined identifiers (e.g., IP address, credentials, etc.).

According to example embodiments, the location-aware sensing privacy indication indicates whether the subsequent sensing requests are allowed or disallowed in a specific area.

Further, according to example embodiments, the UE sensing privacy indication indicates whether the subsequent sensing requests are allowed or disallowed for a specific UE and/or whether to be involved in the sensing procedure.

Further, according to example embodiments, the object-aware sensing privacy indication indicates whether the subsequent sensing requests are allowed or disallowed for a specific object, according to the respective descriptors.

### The above-mentioned profiles and the comprising features/information consist of two aspects:

How to configure and/or execute a sensing procedure, and
How and whether to expose the sensing data outputs.

According to example embodiments, different network functions are used to store for different parts of a sensing privacy profile. For instance, the UDM/UDR may be used for user related privacy profile information (e.g., UE sensing privacy indication), and another dedicated repository or function (e.g., sensing data management function, SeMF) may be used for non-user related privacy information (e.g., location-aware sensing privacy indication and object-aware sensing privacy indication).

According to further example embodiments, the UE sensing privacy indication is part of the LCS privacy profile stored in the UDM for a UE subscriber.

With respect to the above outlined definition of new privacy profiles and their management to address the issue how an AF and a UE can define privacy profiles appropriate for a sensing service, according to example embodiments, setting/registration of sensing privacy profiles may be implemented as follows.

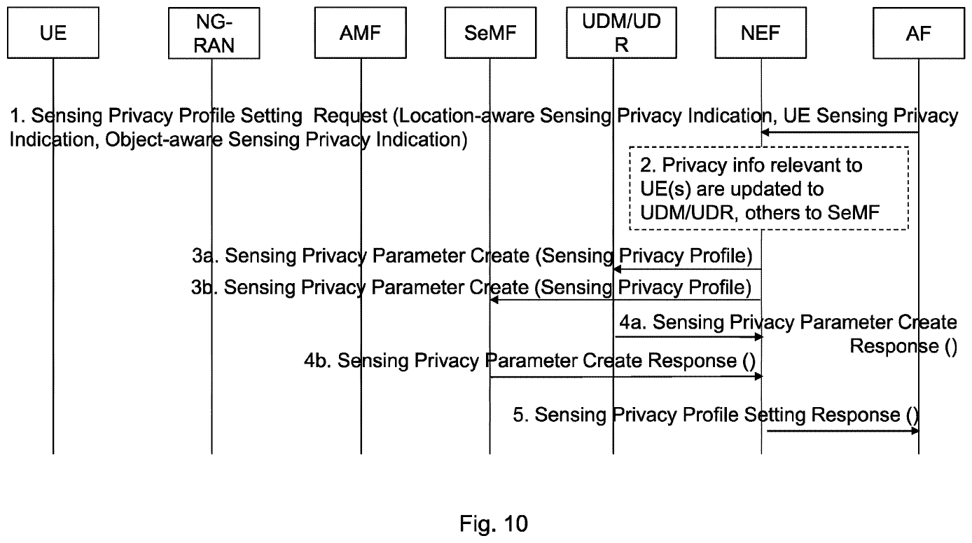

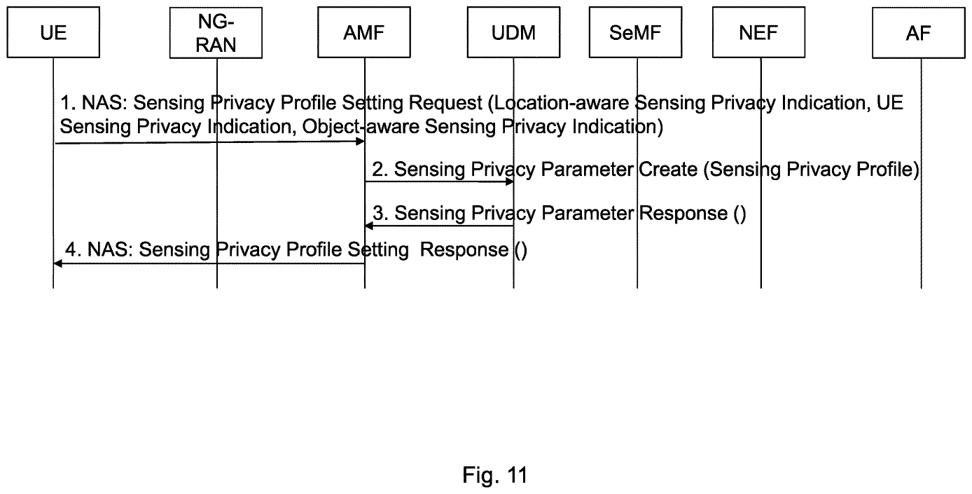

In detail, according to example embodiments, the sensing privacy profiles can be set by an external entity via an AF (e.g., a regulator or a building owner) as shown in FIG. 10, or by a UE as shown in FIG. 11. Both can set and modify any type and parameter of a sensing privacy profile defined above. It is rational to consider that a UE can set a UE sensing privacy indication, while an AF can set a location-aware sensing privacy indication and/or an object-aware sensing privacy indication. However, example embodiments are not limited to such assignment.

FIG. 10 shows a schematic diagram of signaling sequences according to example embodiments, and in particular illustrates signaling of a new procedure for sensing privacy setting initiated by an AF.

As illustrated in FIG. 10, the AF requests the 5GS via the NEF the sensing privacy profile information (described above).

According to example embodiments, the AF uses a new service or uses an existing service with enhancements, e.g., Nnef_ParameterProvision_Create (Step 1).

According to example embodiments, the AF may request to update or delete a sensing privacy profile using new a service or using an existing service with enhancements e.g., Nnef_ParameterProvision_Update and Nnef_ParameterProvision_Delete, respectively.

If the AF is authorized by the NEF to provision the parameters, then the NEF stores in the 5GC data repository. This data repository could be for example UDM/UDR or SeMF.

The NEF may optionally determine to selectively store UE specific privacy setting to UDM/UDR and the others (i.e. non-UE/general privacy setting) to SeMF or to any storage database.

Accordingly, according to example embodiments, the NEF requests the UDM/UDR to create, update and store, or delete the provisioned parameters (e.g., via Nudm_ParameterProvision_Create, Nudm_ParameterProvision_Update Request message), which includes the sensing privacy profile information (Steps 3a and 3b).

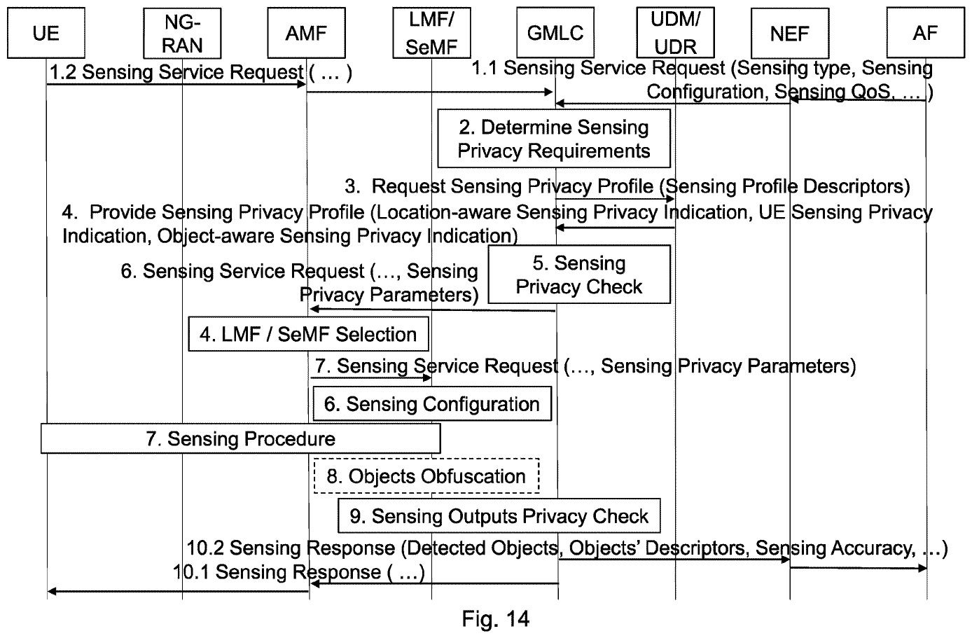

In order to support architecture as in FIG. 14 discussed below, the NEF may just forward received information from AF to GMLC, i.e., before steps 3a and 3b.

If the AF is not authorized to provide the sensing privacy profiles, then the NEF indicates the reason of the failure in a sensing privacy profile setting response message (e.g., using Nnef_ParameterProvision_Create/Update/Delete Response message).

According to example embodiments, the UDM and/or SeMF responds to the request with a sensing privacy parameter create response indicating its successful or unsuccessful creation or update of a sensing privacy profile. If the procedure has failed, the cause value indicates the reason (Step 4a and 4b).

According to example embodiments, the NEF provides the response to the AF, e.g., via a Nnef_ParameterProvision_Create/Update/Delete Response message (Step 5).

FIG. 11 shows a schematic diagram of signaling sequences according to example embodiments, and in particular illustrates signaling of a new procedure for UE specific sensing privacy setting initiated by a UE.

As illustrated in FIG. 11, according to example embodiments, then the UE sends sensing privacy profile information (UE sensing privacy indication, location-aware sensing privacy indication, or object-aware sensing privacy indication, as described above) to the AMF.

The UE may send to AMF for example via UE sensing privacy profile setting request in a N1 NAS message (Step 1).

According to example embodiments, the AMF requests the UDM to create, update and store the provisioned parameters (e.g., via Nudm_ParameterProvision_Create, Nudm_ParameterProvision_Update Request message), which includes the sensing privacy profile information (Step 2).

According to example embodiments, the UDM can also store or update the privacy profile in the UDR e.g., by invoking a Nudr_DM_Update (SUPI, Subscription Data) service operation accordingly in the case of a UE sensing privacy indication.

According to example embodiments, the UDM responds to the AMF with a sensing privacy parameter create response indicating its successful or unsuccessful creation or update of a sensing privacy profile. If the procedure failed, the cause value indicates the reason (Step 3).

According to example embodiments, the AMF responds to the UE via a sensing privacy profile setting response in an N1 NAS message (Step 4).

According to example embodiments, the UDM can use the UDR, e.g., by means of Nudr_DM, to allow the UDR and/or other NF consumers to retrieve, create, update, subscribe for change notifications, unsubscribe for change notifications and delete sensing privacy profiles stored in the UDR, based on the set of data applicable to the consumer.

According to example embodiments, a network function (NF) or management entity (e.g., OAM) may also generate or update sensing-related privacy settings using the signaling of FIG. 10.

After the successful completion of step 3 either in an AF-initiated process (FIG. 10) or of step 2 in the context of a UE-initiated process (FIG. 11), according to example embodiments, the UDM (or SeMF) can notify the subscribed NF (e.g. SeMF, GMLC, NEF) about the updated sensing privacy profile, e.g., via Nudm_SDM_Notification Notify message. This information could be used in ongoing or future sensing procedures and/or privacy checks.

In the above description, it was assumed that UDM and UDR are used to manage and store, respectively, sensing privacy profiles. However, according to example embodiments, other network functions (existing or new) could be used to store and manage sensing privacy profiles, especially for non UE specific privacy profiles (see FIG. 10) for sensing privacy setting initiated either by a UE or by an AF. In that case, the setting/registration of sensing privacy profiles described above takes places with the other network functions (e.g., SeMF, sensing data management function, etc.).

With respect to the above outlined definition of enforcement of the privacy and rules to address the issue as to which the new privacy checks are that are needed for sensing services, according to example embodiments, sensing privacy checks may be implemented as follows.

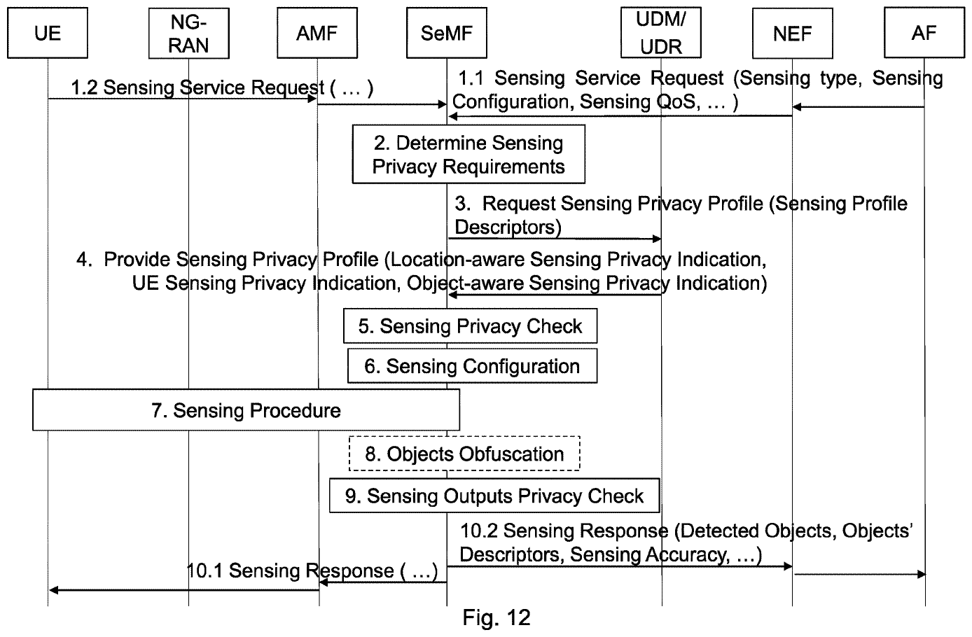

FIG. 12 shows a schematic diagram of signaling sequences according to example embodiments, and in particular illustrates signaling of a new procedure ensuring privacy concerns related to the sensing service request and corresponding sensing service response.

When a sensing client (e.g., UE, AF, BS, NF) sends a sensing request to the SeMF directly (NAS or SBA) or via NEF, according to example embodiments, privacy checks are made at the SeMF. FIG. 12 presents the signaling of an example procedure for the privacy checks after the reception of a sensing service request according to example embodiments.

According thereto, the SeMF performs authorization of the sensing client, and according to the type and the attributes of the sensing service request, the SeMF can determine the respective privacy requirements as well as privacy checks that should be made (step 2).

According to example embodiments, the SeMF requests from the UDM the sensing privacy profile information (step 3), where the request includes the descriptor of required privacy information such as identifiers of involved UEs (e.g., SUPI), target sensing area, target/requested objects etc.

According to example embodiments, the SeMF further requests the non UE specific privacy profile (information) from other storage or itself (depends on where non UE specific privacy profile is stored) (step 3), where the request includes the descriptor of required privacy information such as identifiers of involved target sensing area, target/requested objects, etc.

According to example embodiments, the UDM and/or other NF storing the non UE privacy profile retrieves the appropriate profile and provides to the SeMF (Step 4) the sensing privacy profile information:
sensing privacy profiles of the target UE(s): in the case of a sensing request for one or more UEs identified e.g. by its GPSI or SUPI,
sensing privacy profiles of the target sensing area: in the case of a sensing request for a defined area, e.g., described by GPS coordinates or other positioning information,
sensing privacy profiles of the target object: to get the privacy settings of the objects identified e.g. by the object type, object category, object's features, etc.

According to example embodiments, the UDM and/or other NF storing the non UE privacy profile settings may also indicate the need to obfuscate objects or specific type of objects, providing also information about the obfuscation configuration, method, etc.

According to the different options for sensing privacy profiles discussed above, part or all of a sensing privacy profile or specific sensing privacy profiles (e.g., sensing privacy profiles of the target sensing area, sensing privacy profiles of the target object) may be stored in the SeMF or another dedicated function, e.g., sensing data management.

According to example embodiments, the SeMF conducts the appropriate privacy checks based on the (all) received privacy profiles and the information in the sensing service request (Step 5). For instance, if a sensing process is not allowed, according to the sensing privacy profile, in the described “Location of Sensing” of the sensing service request, then the process may stop and a notification for the reason of the failure may be provided to the sensing client. In addition, as another example, if the requested “Sensing Granularity/Resolution” is not allowed, according to the sensing privacy profile, then an alternative “Sensing Resolution” may be provided if this is acceptable by the sensing client or the sensing process to stop, indicating the reason of the failure.

Thereinafter, according to example embodiments, the SeMF determines the appropriate sensing configuration, according to the requirements included in the sensing service request and taking into consideration restrictions or parameters provided by the retrieved sensing privacy profiles (step 6), which can be provided to the entities involved in a sensing procedure (e.g., base station (BS), UE, etc.).

According to example embodiments, the SeMF in collaboration with the involved BSs and/or UEs requests and collects sensing measurement information, according to the selected sensing method. Based on the received inputs, the SeMF determines the sensing output (step 7).

Optionally, in step 8, the SeMF can obfuscate the objects that have been detected in step 7. The SeMF can change/blur/mask the detected objects to modify one or more of their features (e.g., shape, location, size, etc.), according to pre-configured information and/or privacy sensing profiles received by the UDM.

According to example embodiments, the SeMF can also apply additional privacy checks (step 9), on the detected objects according to privacy profiles that have been retrieved by the UDM/UDR.

Similarly to step 5, the privacy checks can afford one or more of the following aspects: detected UE(s), the sensing area, detected objects, etc., and using information from sensing privacy profiles.

Finally, according to example embodiments, the SeMF provides the sensing service response to the sensing client (e.g., to the AF via the NEF).

As another option, the NEF or any existing network function could undertake a part or the whole functionality of “sensing privacy check” of step 5 of FIG. 12. In that case, the NEF or an existing network function retrieves sensing privacy profiles from the UDM or another NF (e.g., SeMF). In addition, the NEF can also undertake to conduct the sensing output privacy check (Step 9 of FIG. 12).

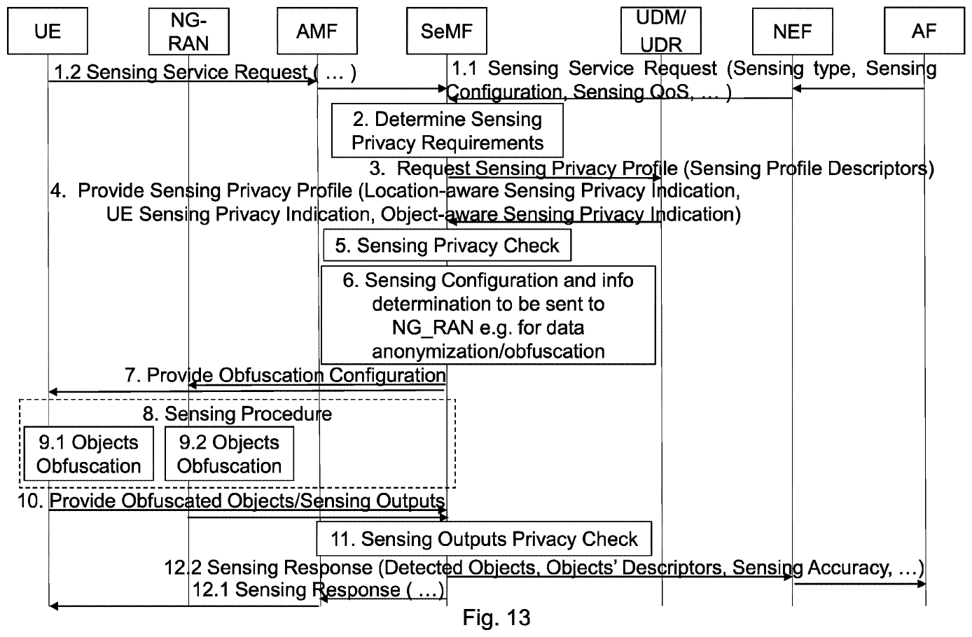

FIG. 13 shows a schematic diagram of signaling sequences according to example embodiments, and in particular illustrates a procedure to enable and configure the obfuscation before providing the sensing response to the requested sensing services.

In particular, as a further option, the obfuscation takes place at the RAN side or both at the RAN and CN network side (e.g., SeMF).

In that case, as it is shown in FIG. 13 (Step 7), after the sensing privacy check and the determination of the sensing configurations and determination of privacy information required for anonymization/obfuscation and/or privacy checks, according to example embodiments, the SeMF provides the indication to enable the obfuscation and provides the obfuscation configuration to the RAN entities (e.g., BSs) and/or UEs involved in the sensing process, or the SeMF itself can perform the obfuscation.

According to example embodiments, obfuscation information can be dedicated messages and/or part of other sensing relevant messages transmitted using NAS and/or RRC and/or application protocol (NGAP) signaling.

According to example embodiments, the obfuscation configuration may indicate the type of obfuscation that should be applied:
the features of the objects that should be changed/blurred/masked (e.g., object's size, shape, location accuracy),
the type of the obfuscation to be applied either by referring to a specific method from a list of methods or by describing the modifications to be applied to a specific feature of an object (e.g., instead of providing the exact shape of an object to represent them as a geometric shape), and/or
to remove features of an object that could directly indicate the identity of the object.

According to example embodiments, the involved UEs and/or RAN entities that have received the obfuscation configuration apply the received configuration during the sensing process and/or before providing their sensing outputs to another entity (e.g., the SeMF), as shown at step 9 of FIG. 13.

FIG. 14 shows a schematic diagram of signaling sequences according to example embodiments, and in particular illustrates signaling of a new procedure ensuring privacy concerns related to the sensing service request and corresponding sensing service response in a sensing service request using enhancements to the existing LCS architecture.

Specifically, this example shows enhancements of existing interfaces of existing location service (presented e.g. in TS 23.273) to provide sensing service.

The GMLC is the entity that receives the sensing request from the sensing client (e.g., AF) and conducts the steps 2 to 5 of FIG. 12, including:
determining the respective privacy requirements as well as privacy checks that should be made,
requesting and receiving the sensing privacy profile information from the UDM; according to example embodiments, the GMLC may invoke Nudm_SDM_Get service operation towards the UDM to retrieve the appropriate privacy settings, and/or
checking the sensing privacy profile in conjunction with the sensing service request; for instance, if one or more UEs or an area are not allowed to be sensed, then, according to example embodiments, the following/subsequent steps are skipped and notifications are provided to the sensing client.

Thereinafter, according to example embodiments, the GMLC provides the sensing privacy parameters to the AMF and then to the LMF (or SeMF), to be taken into consideration at the sensing configuration and/or sensing procedure. The GMLC is also involved in an additional privacy checks (step 9), on the detected objects according to privacy profiles that have been retrieved by the UDM/UDR or new NF.

The above-described procedures and functions may be implemented by respective functional elements, processors, or the like, as described below.

In the foregoing example description of the network entity, only the units that are relevant for understanding the principles of the disclosure have been described using functional blocks. The network entity may comprise further units that are necessary for its respective operation. However, a description of these units is omitted in this specification. The arrangement of the functional blocks of the devices is not construed to limit the disclosure, and the functions may be performed by one block or further split into sub-blocks.

When in the foregoing description it is stated that the apparatus, i.e. network entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

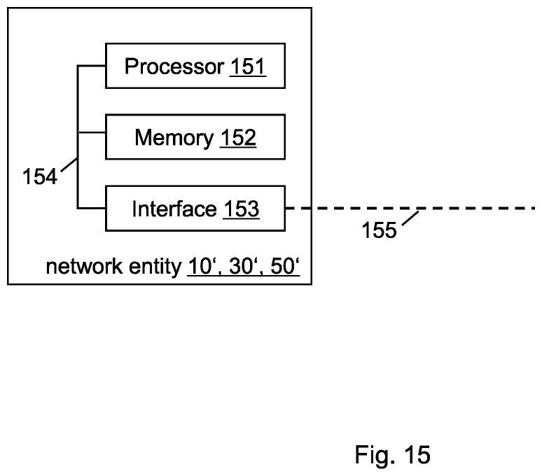

In FIG. 15, an alternative illustration of apparatuses according to example embodiments is depicted. As indicated in FIG. 15, according to example embodiments, the apparatus (network node or entity) 10′ (corresponding to the network node or entity 10) comprises a processor 151, a memory 152 and an interface 153, which are connected by a bus 154 or the like. Further, according to example embodiments, the apparatus (network node or entity) 30′ (corresponding to the network node or entity 30) comprises a processor 151, a memory 152 and an interface 153, which are connected by a bus 154 or the like. Further, according to example embodiments, the apparatus (network node or entity) 50′ (corresponding to the network node or entity 50) comprises a processor 151, a memory 152 and an interface 153, which are connected by a bus 154 or the like. The apparatuses 10′, 30′, 50′ may be connected via link 155 with other apparatuses, e.g. respective others of apparatuses 10′, 30′, 50′.

The processor 151 and/or the interface 153 may also include a modem or the like to facilitate communication over a (hardwire or wireless) link, respectively. The interface 153 may include a suitable transceiver coupled to one or more antennas or communication means for (hardwire or wireless) communications with the linked or connected device(s), respectively. The interface 153 is generally configured to communicate with at least one other apparatus, i.e. the interface thereof.

The memory 152 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to example embodiments, an apparatus representing the network node or entity 10 comprises at least one processor 151, at least one memory 152 including computer program code, and at least one interface 153 configured for communication with at least another apparatus. The processor (i.e. the at least one processor 151, with the at least one memory 152 and the computer program code) is configured to perform generating sensing services related privacy profile information indicative of a profile type of a sensing services related privacy profile corresponding to said sensing services related privacy profile information (thus the apparatus comprising corresponding means for generating), and to perform transmitting said sensing services related privacy profile information, wherein said sensing services related privacy profile information include an indication whether sensing with respect to a profile type dependent sensing target associated with said sensing services related privacy profile information is allowed (thus the apparatus comprising corresponding means for transmitting).

According to example embodiments, an apparatus representing the network node or entity 30 comprises at least one processor 151, at least one memory 152 including computer program code, and at least one interface 153 configured for communication with at least another apparatus. The processor (i.e. the at least one processor 151, with the at least one memory 152 and the computer program code) is configured to perform receiving sensing services related privacy profile information indicative of a profile type of a sensing services related privacy profile corresponding to said sensing services related privacy profile information (thus the apparatus comprising corresponding means for receiving), and to perform storing said sensing services related privacy profile information, wherein said sensing services related privacy profile information include an indication whether sensing with respect to a profile type dependent sensing target associated with said sensing services related privacy profile information is allowed (thus the apparatus comprising corresponding means for storing).

According to example embodiments, an apparatus representing the network node or entity 50 comprises at least one processor 151, at least one memory 152 including computer program code, and at least one interface 153 configured for communication with at least another apparatus. The processor (i.e. the at least one processor 151, with the at least one memory 152 and the computer program code) is configured to perform receiving a sensing service request (thus the apparatus comprising corresponding means for receiving), and to perform performing a sensing privacy check in relation to said sensing service request based on sensing services related privacy profile information indicative of a profile type of a sensing services related privacy profile corresponding to said sensing services related privacy profile information, wherein said sensing services related privacy profile information include an indication whether sensing with respect to a profile type dependent sensing target associated with said sensing services related privacy profile information is allowed (thus the apparatus comprising corresponding means for performing (or means for checking)).

For further details regarding the operability/functionality of the individual apparatuses, reference is made to the above description in connection with any one of FIGS. 1 to 14, respectively.

For the purpose of the present disclosure as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for sensing service privacy. Such measures in one embodiment comprise generating sensing services related privacy profile information indicative of a profile type of a sensing services related privacy profile corresponding to said sensing services related privacy profile information, and transmitting said sensing services related privacy profile information, wherein said sensing services related privacy profile information include an indication whether sensing with respect to a profile type dependent sensing target associated with said sensing services related privacy profile information is allowed.

Even though the disclosure is described above with reference to the examples according to the accompanying drawings, it is to be understood that the disclosure is not restricted thereto. Rather, it is apparent to those skilled in the art that the present disclosure can be modified in many ways without departing from the scope of the inventive idea as disclosed herein.

### LIST OF ACRONYMS AND ABBREVIATIONS

3GPP Third Generation Partnership Project
AF application function
AGV automated guided vehicle
AMF access and mobility management function
AMR autonomous mobile robots
BS base station
DL downlink
GMLC gateway mobile location center
GPS global positioning system
GPSI generic public subscription identifier
ISAC integrated sensing and communication
LCS location service
LMF location management function
NAS Non-access Stratum
NEF network exposure function
OAM operations, administration and maintenance
NF network function
NLOS non-light of sight
PCF policy control function
PLMN Public Land Mobile Network
Qos quality of service
SeMF sensing management function
SNPN stand-alone non-public network
V2X vehicular-to-everything
U2N UE-to-network
UAV unmanned aerial vehicles
UDM unified data management
UDR unified data repository
URI uniform resource identifier
SUPI subscription permanent identifier
UE user equipment
UL uplink
VR virtual reality
XR extended reality

1. A method comprising:
generating sensing services related privacy profile information indicative of a profile type of a sensing services related privacy profile corresponding to said sensing services related privacy profile information; and
transmitting said sensing services related privacy profile information,
wherein said sensing services related privacy profile information include an indication whether sensing with respect to a profile type dependent sensing target associated with said sensing services related privacy profile information is allowed.

2. The method according to claim 1, wherein said profile type is at least one of the following:
location-aware sensing privacy related,
terminal sensing privacy related, or
object-aware sensing privacy related.

3. The method according to claim 2, wherein:
said profile type is location-aware sensing privacy related, and
said sensing services related privacy profile information include at least one of the following:
information on a geographical area corresponding to said profile type dependent sensing target,
information on a sensing allowance configuration,
information on a validity time of said sensing services related privacy profile information,
information on exceptions from said sensing services related privacy profile information,
information on objects obfuscation,
information on a validity time of said indication,
information on receivers of outputs of a sensing procedure considering said sensing services related privacy profile information, or
information on a setting entity setting said sensing services related privacy profile information.

4. The method according to claim 2, wherein:
said profile type is terminal sensing privacy related, and
said sensing services related privacy profile information include at least one of the following:
information on a sensing allowance configuration,
information on a geographical area for which said indication is valid,
information on a time or time period for which said indication is valid, or
information on a sensing services role of said profile type dependent sensing target.

5. The method according to claim 2, wherein:
said profile type is object-aware sensing privacy related, and
said sensing services related privacy profile information include at least one of the following:
information on an object type of said profile type dependent sensing target,
information on a sensing allowance configuration, or
information on receivers of outputs of a sensing procedure considering said sensing services related privacy profile information.

6. The method according to claim 3, wherein said sensing allowance configuration defines at least one of the following:
that obfuscation of object features is enabled, or
that no identifier of an object or a terminal is indicated.

7. The method according to claim 1, wherein in relation to said transmitting, the method further comprises sending said sensing services related privacy profile information with a sensing services privacy profile setting request or a sensing services privacy profile create request or a sensing services privacy profile update request.

8. The method according to claim 1, further comprising transmitting a sensing services privacy profile deletion request indicative of a sensing services related privacy profile.

9. A method comprising:
receiving sensing services related privacy profile information indicative of a profile type of a sensing services related privacy profile corresponding to said sensing services related privacy profile information; and
storing said sensing services related privacy profile information,
wherein said sensing services related privacy profile information include an indication whether sensing with respect to a profile type dependent sensing target associated with said sensing services related privacy profile information is allowed.

10. The method according to claim 9, further comprising determining at least one network entity to store the received sensing services related privacy profile information.

11. The method according to claim 10, wherein the storage device comprises at least one of a unified data repository (UDR) or unified data management (UDM) or a Sensing Management Function (SeMF) or any storage database.

12. The method according to claim 9, wherein said profile type is at least one of the following:
location-aware sensing privacy related,
terminal sensing privacy related, or
object-aware sensing privacy related.

13. The method according to claim 12, wherein:
said profile type is location-aware sensing privacy related, and
said sensing services related privacy profile information include at least one of the following:
information on a geographical area corresponding to said profile type dependent sensing target,
information on a sensing allowance configuration,
information on a validity time of said sensing services related privacy profile information,
information on exceptions from said sensing services related privacy profile information,
information on objects obfuscation,
information on a validity time of said indication,
information on receivers of outputs of a sensing procedure considering said sensing services related privacy profile information, or
information on a setting entity setting said sensing services related privacy profile information.

14. The method according to claim 12, wherein:
said profile type is terminal sensing privacy related, and
said sensing services related privacy profile information include at least one of the following:
information on a sensing allowance configuration,
information on a geographical area for which said indication is valid,
information on a time or time period for which said indication is valid, or
information on a sensing services role of said profile type dependent sensing target.

15. The method according to claim 12, wherein:
said profile type is object-aware sensing privacy related, and
said sensing services related privacy profile information include at least one of the following:
information on an object type of said profile type dependent sensing target,
information on a sensing allowance configuration, or
information on receivers of outputs of a sensing procedure considering said sensing services related privacy profile information.

16. The method according to claim 13, wherein said sensing allowance configuration defines at least one of the following:
that obfuscation of object features is enabled, or
that no identifier of an object or a terminal is indicated.

17. The method according to claim 9, wherein said sensing services related privacy profile information are received with a sensing services privacy profile setting request or a sensing services privacy profile create request or a sensing services privacy profile update request.

18. The method according to claim 9, further comprising:
receiving a sensing services privacy profile deletion request indicative of a sensing services related privacy profile, and
deleting said sensing services related privacy profile information corresponding to said sensing services related privacy profile.

19. The method according to claim 9, further comprising transmitting, to at least one subscriber entity, a subscription notification indicative of a sensing services related privacy profile change.

20. The method according claim 9, further comprising:
receiving a sensing service request, and
performing a sensing privacy check in relation to said sensing service request based on said sensing services related privacy profile information.

21-41. (canceled)
